(19) United States
(12) Patent Application Publication
(10) Pub. No.: US 2026/0077713 A1
(43) Pub. Date: Mar. 19, 2026

(54) PREVENTION OF SIDE DOOR MISHAP USING EXISTING TIME OF FLIGHT (TOF) SENSORS

(71) Applicant: GM Global Technology Operations LLC, Detroit, MI (US)

(72) Inventors: Sookhyoung Shin, Incheon (KR); Myosin Jung, Gyeonggi-do (KR); Minhyung Kang, Bucheon-si (KR); Sunyoon Park, Gyeonggi-do (KR); Younghoon Kim, Seoul (KR)

(73) Assignee: GM Global Technology Operations LLC, Detroit, MI (US)

(21) Appl. No.: 18/890,143

(22) Filed: Sep. 19, 2024

(51) Int. Cl. B60Q 9/00; E05B 77/54; G01C 21/20

(52) U.S. Cl. CPC B60Q 9/008; E05B 77/54; G01C 21/20

(57) ABSTRACT

The system and method include receiving sensor data captured by a sensor system of a vehicle and mapping the sensor data to generate a depth map of a proximity zone around the vehicle. Here, the depth map includes an object in the proximity zone around the vehicle. The system and method also include determining whether the object in the proximity zone is within a zone of interest corresponding to a door of the vehicle and, when the object is within the zone of interest of the door of the vehicle, generating a notification for a user of the vehicle, the notification warning the user that the door is not clear to open.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method of preventing door mishaps using existing time of flight (TOF) sensors of a vehicle. In particular, when a user exits a vehicle, sufficient space adjacent to the door of the user is needed to prevent damage to the door from objects (e.g., other vehicles, walls, pillars, etc.) proximate to the door. To remedy this, the user may either need to re-park the vehicle to adjust the location of the vehicle within a parking space or find a new parking space entirely.

While dedicated sensors and cameras for preventing collisions are available, these dedicated sensors and cameras require additional devices and integration with a vehicle that limits the use of such sensors and cameras to high-end vehicles. As such, a solution that detects objects on the side of a vehicle that can be universally applied to all vehicles of a manufacturer while limiting added weight is desirable. Moreover, when parking a vehicle, a user may benefit from advance notice that the vehicle will be at risk of damage to a door and/or advance notice that a parking spot has insufficient space that may prompt the user to select a different space to park.

### SUMMARY

One aspect of the disclosure provides a computer-implemented method for the prevention of door mishaps using existing time of flight (TOF) sensors that when executed on data processing hardware causes the data processing hardware to perform operations that include receiving sensor data captured by a sensor system of a vehicle and mapping the sensor data to generate a depth map of a proximity zone around the vehicle, the depth map including an object in the proximity zone around the vehicle. The operations also include determining whether the object in the proximity zone is within a zone of interest corresponding to a door of the vehicle. When the object is within the zone of interest of the door of the vehicle, the operations further include generating a notification for a user of the vehicle, the notification warning the user that the door is not clear to open.

Implementations of the disclosure may include one or more of the following optional features. In some implementations, the operations further include receiving vehicle data of the vehicle, the vehicle data including one or more of vehicle position, vehicle steering, or vehicle speed. In these implementations, mapping the sensor data to generate the depth map of the proximity zone around the vehicle may include reconciling the vehicle data of the vehicle with the sensor data captured by the sensor system of the vehicle.

In some examples, the operations further include receiving seat data indicating that a seat associated with the door of the vehicle is occupied. In these examples, generating the notification warning the user that the door is not clear to open may include identifying the zone of interest that corresponds to the occupied seat. In some implementations, generating the notification to the user of the vehicle includes displaying, on a display in communication with the data processing hardware, the notification. In these implementations, generating the notification to the user of the vehicle may further include one or more of locking the door that is not clear to open, generating a visual alert, or generating an audio alert.

In some examples, the zone of interest is configured during a configuration process. In some implementations, a dimension of the zone of interest is adjustable. In some examples, the operations further include detecting a vehicle gear of the vehicle and generating the notification for the user of the vehicle when the vehicle gear indicates that the vehicle is parked.

Another aspect of the disclosure provides a computer-implemented method for the prevention of door mishaps using existing time of flight (TOF) sensors that when executed on data processing hardware causes the data processing hardware to perform operations that include, while a vehicle is executing a parking procedure, receiving sensor data captured by a sensor system of the vehicle, mapping the sensor data to generate a depth map of a proximity zone around the vehicle, the depth map including an object in the proximity zone around the vehicle, and determining whether the object in the proximity zone is within a zone of interest corresponding to a door of the vehicle. When the object is within the zone of interest of the door of the vehicle, these operations also include displaying, on a display in communication with the data processing hardware, an indication highlighting the zone of interest.

This aspect may include one or more of the following optional features. In some implementations, the operations further include receiving vehicle data of the vehicle, the vehicle data including one or more of vehicle position, vehicle steering, or vehicle speed. In these implementations, mapping the sensor data to generate the depth map of the proximity zone around the vehicle may include reconciling the vehicle data of the vehicle with the sensor data captured by the sensor system of the vehicle.

Another aspect of the disclosure provides a system for prevention of door mishaps using existing TOF sensors that includes data processing hardware and memory hardware in communication with the data processing hardware. The memory hardware stores instructions that when executed by the data processing hardware cause the data processing hardware to perform operations that include receiving sensor data captured by a sensor system of a vehicle and mapping the sensor data to generate a depth map of a proximity zone around the vehicle, the depth map including an object in the proximity zone around the vehicle. The operations also include determining whether the object in the proximity zone is within a zone of interest corresponding to a door of the vehicle. When the object is within the zone of interest of the door of the vehicle, the operations further include generating a notification for a user of the vehicle, the notification warning the user that the door is not clear to open.

This aspect may include one or more of the following optional features. In some implementations, the operations further include receiving vehicle data of the vehicle, the vehicle data including one or more of vehicle position, vehicle steering, or vehicle speed. In these implementations, mapping the sensor data to generate the depth map of the proximity zone around the vehicle may include reconciling the vehicle data of the vehicle with the sensor data captured by the sensor system of the vehicle.

In some examples, the operations further include receiving seat data indicating that a seat associated with door of the vehicle is occupied. In these examples, generating the notification warning the user that the door is not clear to open may include identifying the zone of interest that corresponds to the occupied seat, and displaying, on a display in communication with the data processing hardware, the notification. In these implementations, generating the notification to the user of the vehicle may further include one or more of locking the door that is not clear to open, generating a visual alert, or generating an audio alert. In some examples, the zone of interest is configured during a configuration process.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system for prevention of door mishaps using existing time of flight (TOF) sensors.

FIG. 2 is a schematic view of example components of the system of FIG. 1.

FIGS. 3A and 3B are schematic views of a zone of interest configuration process for the system of FIG. 1.

FIG. 4 is an example vehicle executing the system of FIG. 1.

FIG. 5 is an example user interface displaying a warning from the system of FIG. 1.

FIG. 6 is an example user interface displaying a warning from the system of FIG. 1.

FIG. 7 is a flowchart of an example arrangement of operations for a method for the prevention of door mishaps using existing TOF sensors.

FIG. 8 is a flowchart of an example arrangement of operations for a method for the prevention of door mishaps using existing TOF sensors.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

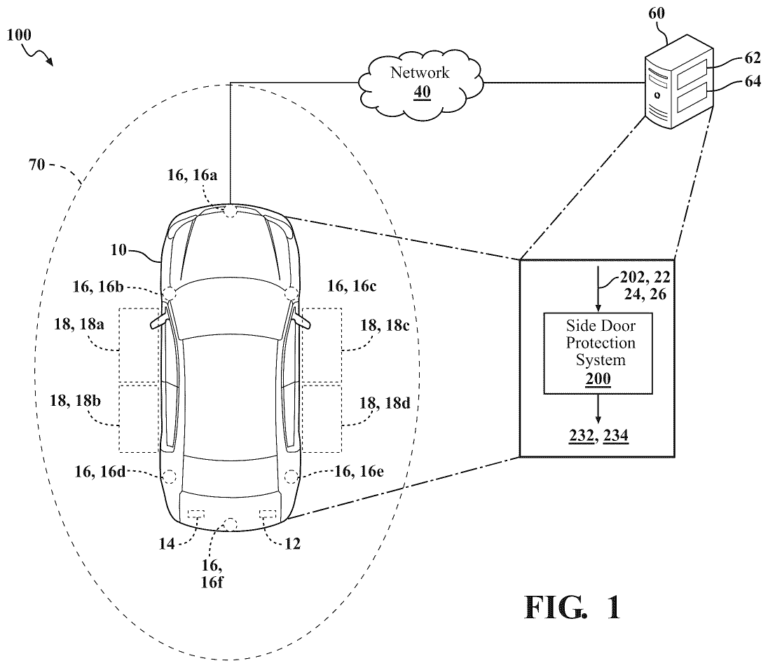

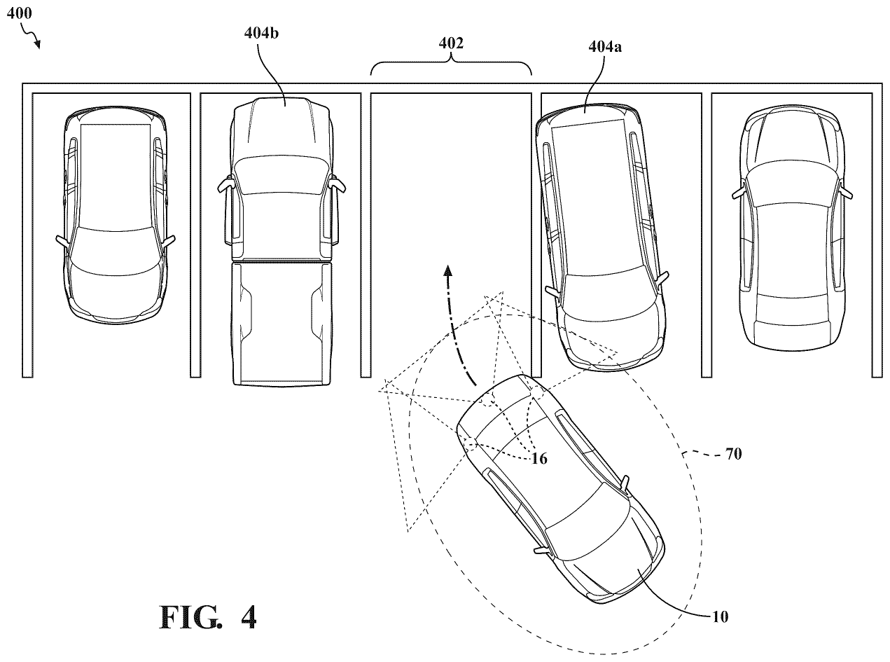

Referring to FIG. 1, in some implementations, a system 100 includes a vehicle 10 and/or a remote system 60 in communication with the vehicle 10 via a network 40 (e.g., wired or wireless communication). The vehicle 10 and/or the remote system 60 execute a side door protection system 200 configured to detect when there is insufficient space around the vehicle 10 to open a door 20 of the vehicle 10 and notify a user of the vehicle 10 when there is insufficient space to open the door 20. Briefly, and as described in further detail below, the side door protection system 200 is configured to receive sensor data 202 and determine whether any objects 404 (FIG. 4) are within a proximity zone 70 of the vehicle 10, and when an object 404 is within a zone of interest 18 corresponding to a door 20 of the vehicle 10, generate a notification 232 warning a user of the vehicle 10 that the door 20 is not clear to open. Notably, by detecting whether there is sufficient side space available to open the door 20 of the vehicle 10 when the vehicle is parked, the side door protection system 200 may prevent damage to the vehicle 10 and/or other objects (e.g., other vehicles, buildings, people, etc.) adjacent to the vehicle 10. Moreover, in instances where the vehicle 10 executes a parking procedure 400 (FIG. 4), the side door protection system 200 may give the user of the vehicle 10 advance notice that a parking spot has insufficient space that may prompt the user to select a different space to park.

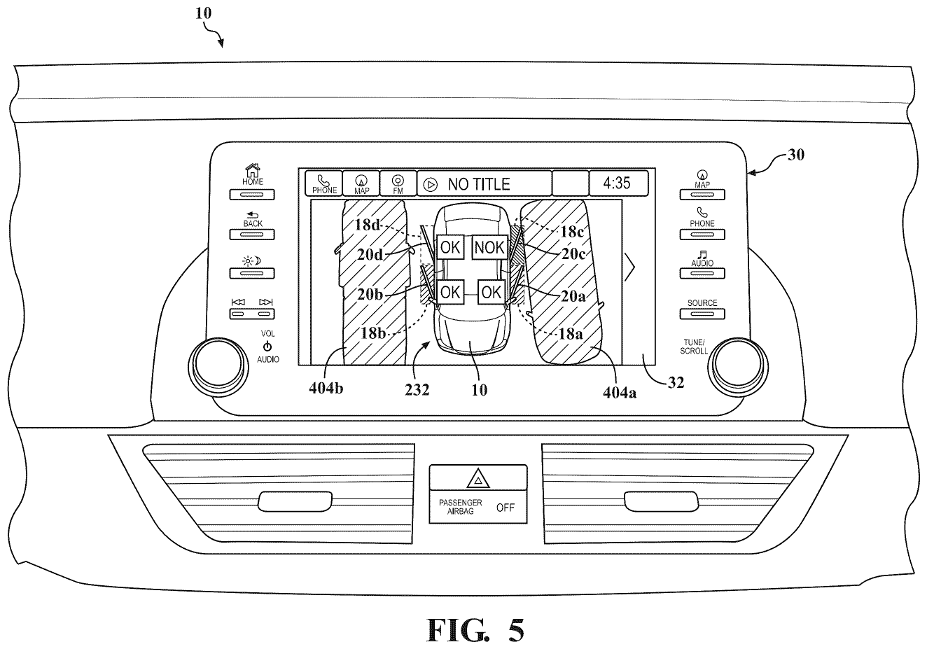

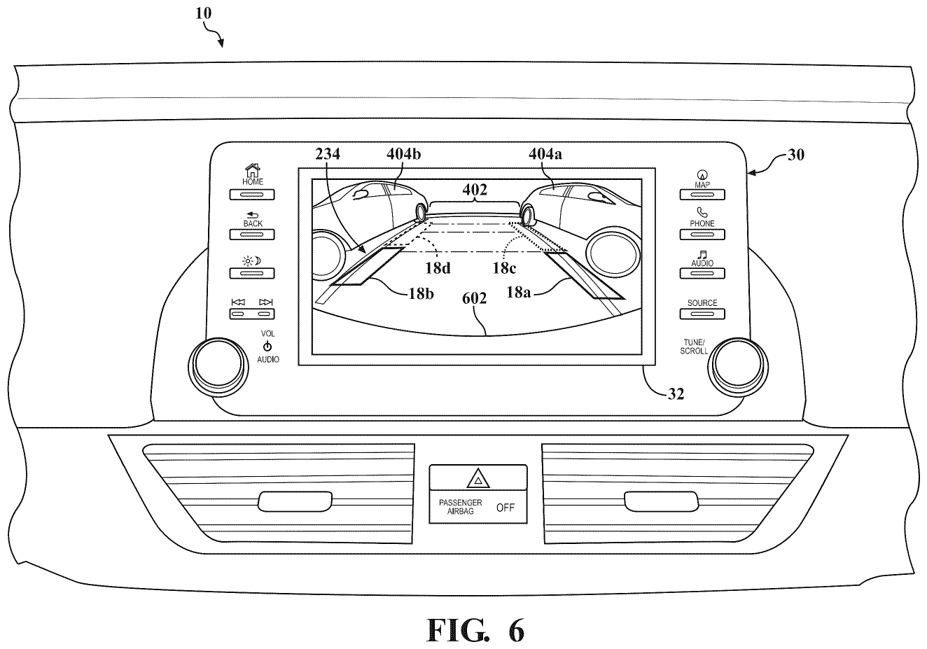

In the example shown, the side door protection system 200 is implemented within the vehicle 10. However, the side door protection system 200 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 12 to perform operations. The vehicle 10 further includes a user interface 30 (FIGS. 5 and 6) having a display 32 configured to display the notification 232 warning the user of the vehicle 10 there is insufficient space to open the door 20. The user interface 30 may be implemented in an infotainment system of the vehicle 10, however it should be appreciated the user interface 30 may be implemented in other computing devices (e.g., computing devices in communication with the vehicle 10), such as, without limitation, a head-up display, a smart phone, tablet, smart display, desktop/laptop, smart watch, smart appliance, or smart glasses/headset.

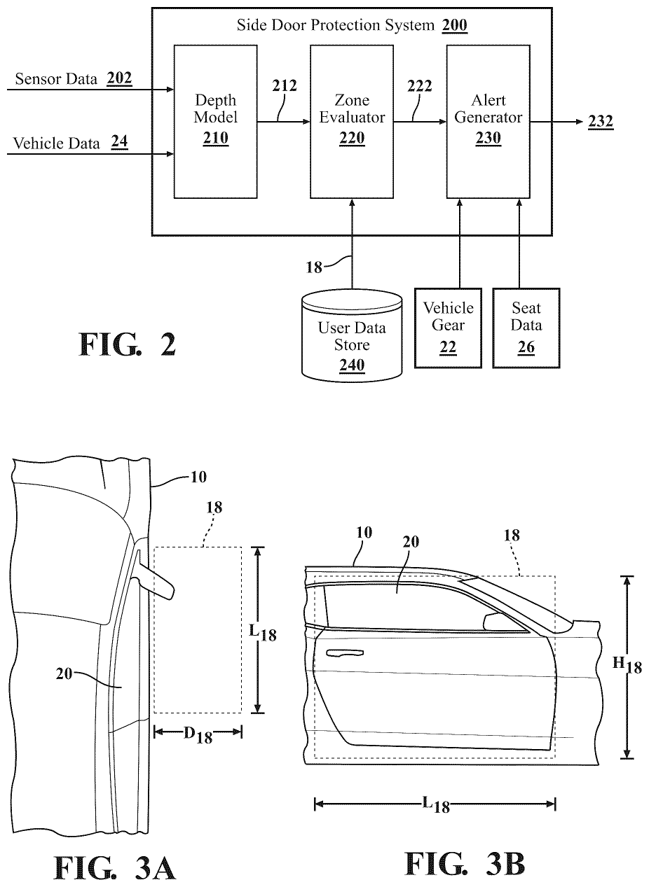

The vehicle 10 may further include a sensor system 16, 16a-16f configured to capture sensor data 202 (FIG. 2) from an environment of the vehicle 10. As shown, the sensor system 16 includes a first, front sensor 16a, a second, forward left sensor 16b, a third, forward right sensor 16c, a fourth, rearward left sensor 16d, a fifth, rearward right sensor 16e, and a sixth, rear sensor 16f. However, it should be appreciated that the sensor system 16 may include any number of sensors 16 in any location of the vehicle 10. Notably, the sensor system 16 may include the existing time of flight (TOF) sensors of the vehicle 10 rather than implementing additional sensors and/or devices that increase the weight of the vehicle 10, the price of the vehicle 10, and the computational complexity of the vehicle 10. Here, the sensor system 16 (i.e., the TOF sensors) may be universally applied to models of all price points that are made by the manufacturer of the vehicle 10.

In some implementations, the sensor system 16 is configured to capture sensor data 202 within a proximity zone 70 that surrounds the exterior of the vehicle 10. As used herein, the proximity zone 70 may include the maximum range that the sensors 16 may accurately sense objects (e.g., other vehicles, structures, people, etc.) around the vehicle 10. While the sensor system 16 includes the discrete sensors about the exterior of the vehicle 10, the sensor data 202 captured by the sensor system 16 may collectively cover the 360-degree area surrounding the vehicle 10. The vehicle 10 also includes four (4) doors 20, 20a-20d configured to allow users of the vehicle 10 to enter and exit the vehicle 10. While the vehicle 10 includes four (4) doors, the side door protection system 200 may be implemented in vehicles with any number of doors such as, without limitation two (2) doors, three (3) doors, four (4) doors, etc.

The remote system 60 (e.g., server, cloud computing environment) also includes data processing hardware 62 and memory hardware 64 storing instructions that when executed on the data processing hardware 62 cause the data processing hardware 62 to perform operations. In some implementations, execution of the side door protection system 200 is shared across the vehicle 10 and/or the remote system 60. In some implementations, the vehicle 10 and/or the remote system 60 execute the side door protection system 200 when the vehicle 10 is parked. Additionally or alternatively, the vehicle 10 and/or the remote system 60 execute the side door protection system 200 when the vehicle 10 executes a parking procedure 400. As used herein, the parking procedure 400 may refer to any movement by the vehicle 10 to park, such as forward, reverse, parallel, etc. In some implementations, the side door protection system 200 detects the parking procedure 400 based on a vehicle gear 22 (e.g., park, drive, reverse) of the vehicle 10.

With reference to FIGS. 1 and 2, the side door protection system 200 executes a depth model 210, a zone evaluator 220, and an alert generator 230. In some implementations, the side door protection system 200 has access to a user data store 240 that records/stores a plurality of zones of interest 18, 18a-18d of the vehicle 10 and any sensor data 202 collected/record during a previous time step. The user data store 240 may be stored on any one of the memory hardware 14, 64. In some implementations, the side door protection system 200 is activated when it detects that a particular vehicle gear 22 of the vehicle 10 indicates that the vehicle 10 is executing a parking procedure 400. For example, the side door protection system 200 may activate when the vehicle gear 22 of the vehicle 10 is reverse (i.e., the vehicle 10 is executing the parking procedure 400 of reversing into a parking space 402).

With reference to FIGS. 2 and 4, the depth model 210 is configured to receive sensor data 202 collected from the proximity zone 70 around the vehicle 10 and generate, as output, a depth map 212 of the proximity zone 70. In particular, the depth model 210 is configured to estimate, based on the sensor data 202, where objects 404 are located within the proximity zone 70. Here, the depth model 210 may continuously, or on a periodic basis, receive the sensor data 202 captured by the sensor system 16, and measure the distance between the vehicle 10 and any objects 404 that are within the proximity zone 70. Thereafter the depth model 210 may compile the measurements derived from the sensor data 202 and generate the depth map 212 estimating the location of the objects 404 relative to the vehicle 10. In some implementations, the depth model 210 receives the sensor data 202 and generates the depth map 212 when the vehicle 10 is parked (e.g., the vehicle gear 22 indicates that the vehicle 10 is parked). Optionally, the depth model 210 may continuously receive the sensor data 202 while the vehicle 10 moves (e.g., executes a parking procedure 400), and map the distribution of objects 404 located next to the doors 20 using the continuously measured distance data to generate the depth map 212. In these instances, the depth model 210 may record the historical sensor data 202 indicating the distance between the vehicle 10 and the objects 404 (e.g., in the user data store 240).

In some implementations, the depth model 210 additionally receives vehicle data 24 of the vehicle 10. For instance, the vehicle data 24 may include one or more of the position of the vehicle 10, the steering data of the vehicle 10, or the speed of the vehicle 10. Here, when the depth model 210 generates the depth map 212, the depth model 210 may reconcile the vehicle data 24 with the sensor data 202 captured by the sensor system 16 of the vehicle 10. For example, the position of the vehicle 10, the steering data of the vehicle 10, and the speed of the vehicle 10 may be used to identify a baseline of where the vehicle 10 is at any moment. The depth model may then correct the distance values derived from the sensor data 202 by sequentially reflecting the amount of change in the position of the vehicle 10 (e.g., using the vehicle data 24). In some implementations, the vehicle data 24 may be used to compensate the measured distances derived from the sensor data 202.

Referring again to FIG. 2, the zone evaluator 220 is configured to receive, as input, the depth map 212 including the one or more objects 404 in the proximity zone 70 of the vehicle 10, and generate, as output, an indication 222 of whether the object 404 is located within a zone of interest 18 corresponding to a door 20 of the vehicle 10. As used herein, the zone of interest 18 for each door 20 of the vehicle 10 may include the three-dimensional space outside of the door 20 in which surrounding objects 404 may be detected as interfering with the door 20 opening.

With particular reference to FIGS. 3A and 3B, an example door 20 and its corresponding zone of interest 18 is shown. In particular, FIG. 3A shows a top plan view of the vehicle 10, where the zone of interest 18 may be defined by a depth D₁₈ that the door 20 may swing through, and a length L₁₈ generally defined by the length of the door 20. Additionally, as shown in FIG. 3B, which shows a side perspective view of the vehicle 10, the zone of interest further includes a height H₁₈ generally defined by the height of the door 20. The length L₁₈ of the zone of interest 18, the depth D₁₈ of the zone of interest 18, and the height H₁₈ of the zone of interest 18 may be configured during a configuration/manufacturing process (e.g., initialization) of the vehicle 10. For example, the depth D₁₈ of the zone of interest 18 may be configured to include a default depth D₁₈ that allows the door 20 to open the minimum space for an adult to exit or enter the vehicle 10. Here, the depth D₁₈ of the zone of interest may include the thickness of the door 20 plus 400 millimeters (400 mm). In some implementations, the depth D₁₈ of the zone of interest 18 is adjustable. For example, a user of the vehicle 10 may adjust the depth D₁₈ of the zone of interest 18 to increase or decrease the depth D₁₈ of the zone of interest 18. For example, the user may adjust the depth D₁₈ of the zone of interest 18 using the user interface 30 of the vehicle 10.

Referring again to FIG. 2, the zone evaluator 220 receives the zones of interest 18 corresponding to the doors 20 of the vehicle 10 and determines whether any objects 404 are within the zones of interest 18 of the vehicle 10. In other words, the zone evaluator 220 determines, based on the depth map 212 and the three-dimensional zones of interest 18, whether the distance between the object 404 in the depth map 212 is less than the relevant dimension (i.e., height H₁₈, length L₁₈, depth D₁₈) in the zone of interest 18. The zone evaluator 220 may, for each zone of interest 18 of the vehicle 10, determine whether the zone of interest 18 is clear of objects 404. In some implementations, the indication 222 generated by the zone evaluator 220 specifies which of the doors 20 of the vehicle 10 have an object 404 within its corresponding zone of interest 18 as well as which of the doors 20 do not have an object 404 within its corresponding zone of interest 18, and as such, are clear to open.

The alert generator 230 may receive the indication 222 generated by the zone evaluator 220 as input and generate, as output, the notification 232 for the user of the vehicle 10. Here, the notification 232 may warn the user that a particular door 20 of the vehicle 10 is not clear to open. The notification 232 may warn the user about more than one door 20 that is not clear to open at the same time. Additionally, the notification 232 may include an indication to the user of which door 20 is clear (i.e., not blocked by anything) to open at that time.

The alert generator 230 may additionally receive, as input, seat data 26 indicating whether a seat associated with a door 20 is occupied. Notably, the side door protection system 200 may only generate the notification 232 for the doors 20 adjacent to occupied seats. The seat data 26 may include data captured by a seat weight sensor, or a seat belt reminder system. Here, the alert generator 230 may receive the seat data 26 and determine which doors 20 are associated with occupied seats. When the seat data 26 indicates that an occupied seat is adjacent to a door 20, the alert generator 230 may include the occupied seat and corresponding door 20 in the notification 232.

In some implementations, the notification 232 for the user is displayed in the display 32 of the user interface 30 of the vehicle 10. With particular reference to FIG. 5, the notification 232 may include an image of the vehicle 10 and the objects 404a, 404b within the proximity zone 70 around the vehicle 10. For example, the alert generator 230 may generate a virtual image showing a graphic of the vehicle 10 and the objects 404a, 404b within the proximity zone 70 based on the depth map 212 generated by the depth model 210. As shown, the vehicle 10 is displayed with objects 404a, 404b (e.g., other vehicles) on either side of the vehicle 10. Here, the object 404a on the side of the vehicle 10 may be parked such that it encroaches on a zone of interest 18 of the vehicle 10, while the object 404b may be within the proximity zone 70, but not within any zones of interest 18 of the vehicle 10. In this example, the side door protection system 200 may detect, via sensor data 202, that the object 404a is within the zone of interest 18c corresponding to the rear passenger door 20c. Moreover, the side door protection system 200 may receive seat data 26 indicating that the rear passenger seat is occupied and, as such, the side door protection system 200 may generate the notification 232 including an indication that the rear passenger door 20c corresponding to the zone of interest 18c is not clear to open. The notification 232 may further include an indication “NOK” indicating that the rear passenger door 20c is not clear to open. Additionally, because the side door protection system 200 does not detect, via sensor data 202 any objects in the zones of interest 18a, 18b corresponding to the front doors 20a, 20b of the vehicle 10, and the seat data 26 indicates that the seats in the front of the vehicle 10 are both occupied, the notification 232 may include an indication that the front doors 20a, 20b are clear to open, and display “OK” indicating that the front doors are clear open. Conversely, while the zone of interest 18d corresponding to the rear passenger door 20d may not include any objects, the seat data 26 indicates that the seat is empty. As such, the notification 232 may either exclude the rear passenger door 20d, or include a visual exclusion (e.g., grayscale) over the rear passenger door 20d.

In some implementations, generating the notification 232 to the user of the vehicle 10 further includes additional safeguards to prevent the door 20 that is not clear to open from being opened. For example, the notification 232 may include instructions to the door 20 to lock the door 20 and prevent it from opening. Here, the door 20 lock may get the attention of the user and give the user time to notice the object 404 in the zone of interest 18. In this example, the door 20 may unlock when the handle is pulled once. Optionally, the notification 232 may include generating a visual alert for the user of the vehicle such as a light that turns off/on and/or blinks to catch the user's attention. Additionally or alternatively, the notification 232 includes an audio alert (e.g., a chime or synthesized speech warning) issued to communicate that one or more of the doors 20 are not clear to open.

In some cases, the alert generator 230 further detects the vehicle gear 22 of the vehicle 10 and only generates the notification 232 when the vehicle gear 22 indicates that the vehicle 10 is parked. Conversely, referring to FIGS. 4 and 6, the side door protection system 200 may execute while the vehicle 10 moving. For example, when the vehicle 10 is executing parking procedure 400, the alert generator 230 may display, in real time, the notification 232 highlighting the zone of interests 18 of the vehicle 10 to alert the user of the vehicle 10 to any objects 404 that may prevent a door 20 from opening when parked.

With particular reference to FIG. 4, a parking procedure 400 for the vehicle 10 is shown. As shown, the parking procedure 400 includes the vehicle 10 backing into a parking space 402 disposed between adjacent objects 404a, 404b (i.e., other vehicles), however it should be understood that the parking procedure 400 may include forward parking as well as parallel parking. As the vehicle 10 moves through a maneuver to park in the parking space 402, the sensor system 16 continuously scans the proximity zone 70 of the vehicle 10 and captures sensor data 202 within the proximity zone 70. For example, while the parking procedure 400 makes the cut into the parking space 402, the depth model 210 may iteratively update a depth map 212 of the parking space 402, starting with sensor data 202 collected from the rear corners of the vehicle 10, and ending with sensor data 202 collected from the side doors. The depth model 210 may identify the objects 404a, 404b, and include the objects 404a, 404b in the depth map 212. Thereafter, the zone evaluator 220 may determine that the trajectory of the vehicle 10 (e.g., based on the vehicle data 24) will place the object 404a within a zone of interest 18 of one of the doors 20 of the vehicle 10.

Referring to FIG. 6, while the vehicle executes the parking procedure 400, the alert generator 230 may generate an indication 234 highlighting the zones of interest 18 of the vehicle 10. For example, as shown, the indication 234 may be displayed in the display 32 of the user interface 30. In particular, the indication 234 is overlain on the existing rear vision view camera image 602. The indication 234 may show the zones of interest 18 in scale with the image 602 captured by the rear vision view camera to provide the user of the vehicle 10 with a distance guideline for the vehicle 10 during the parking procedure 400. Like in FIG. 5, the indication 234 may exclude the zone of interest 18d corresponding to the rear passenger door 20d that has an empty seat, and highlight the zones of interest 18a, 18b corresponding to the front doors 20a, 20b as clear to open. Likewise, the indication 234 highlights the zone of interest 18c corresponding to the door 20c as having an object 404 (i.e., the vehicle 404a). Advantageously, the indication 234 may provide the user with the necessary advance notice to either modify the parking procedure 400 by changing the trajectory of the vehicle 10, re-starting the parking procedure 400, or seeking an alternate parking space without objects 404 that encroach on the parking space 402.

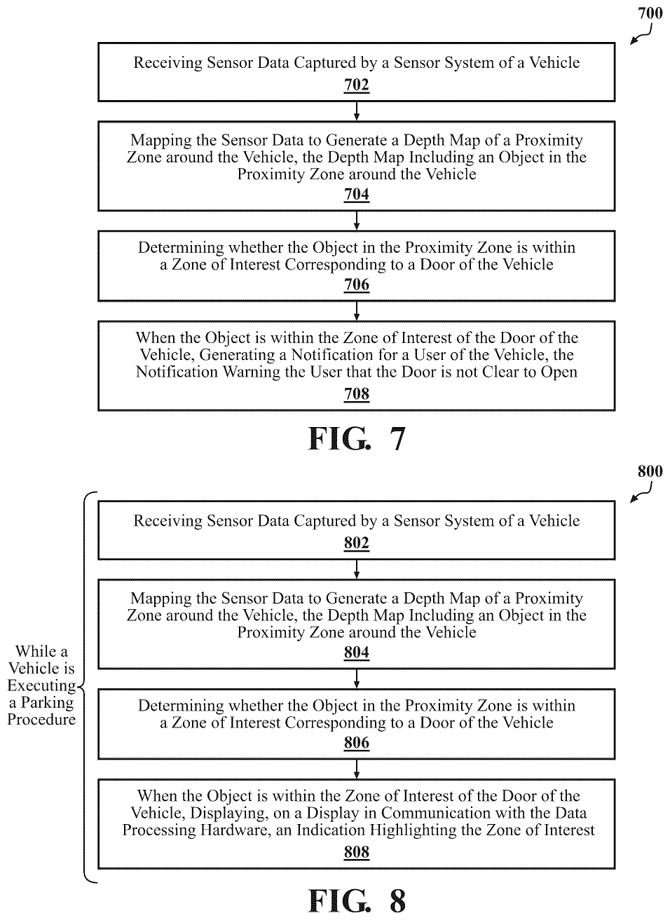

FIG. 7 includes a flowchart of an example arrangement of operations for a method 700 for preventing side door mishaps using existing TOF sensors. The method 700 may be described with reference to FIGS. 1-6. Data processing hardware (e.g., data processing hardware 12, 62 of FIG. 1) may execute instructions stored on memory hardware (e.g., memory hardware 14, 64 of FIG. 1) to perform the example arrangement of operations for the method 700.

At operation 702, the method 700 includes receiving sensor data 202 captured by a sensor system 16 of a vehicle 10. The method 700 also includes, at operation 704, mapping the sensor data 202 to generate a depth map 212 of a proximity zone 70 around the vehicle 10. Here, the depth map 212 includes an object 404 in the proximity zone 70 of the vehicle 10. At operation 706, the method 700 may further include determining whether the object 404 in the proximity zone 70 is within a zone of interest 18 corresponding to a door 20 of the vehicle 10. When the object 404 is within the zone of interest 18 of the vehicle 10, the method 700 further includes, at operation 708, generating a notification 232 for a user of the vehicle 10, the notification 232 warning the user that the door 20 is not clear to open.

FIG. 8 includes a flowchart of another example arrangement of operations for a method 800 for preventing side door mishaps using existing TOF sensors. The method 800 may be described with reference to FIGS. 1-6 and executes while the vehicle 10 is executing a parking procedure 400. Data processing hardware (e.g., data processing hardware 12, 62 of FIG. 1) may execute instructions stored on memory hardware (e.g., memory hardware 14, 64 of FIG. 1) to perform the example arrangement of operations for the method 800.

At operation 802, the method 800 includes receiving sensor data 202 captured by a sensor system 16 of the vehicle 10. At operation 804, the method 800 also includes mapping the sensor data 202 to generate a depth map 212 of a proximity zone 70 around the vehicle 10. Here, the depth map 212 includes an object 404 in the proximity zone 70 around the vehicle 10. At operation 806, the method 800 further includes determining whether the object 404 in the proximity zone 70 is within a zone of interest 18 corresponding to a door 20 of the vehicle 10. When the object 404 is within the zone of interest 18 of the vehicle 10, the method 800 further includes, at operation 808, displaying, on a display 32 in communication with the data processing hardware 12 of the vehicle 10, a notification 232 highlighting the zone of interest 18.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving sensor data captured by a sensor system of a vehicle;
mapping the sensor data to generate a depth map of a proximity zone around the vehicle, the depth map including an object in the proximity zone around the vehicle;
determining whether the object in the proximity zone is within a zone of interest corresponding to a door of the vehicle; and
when the object is within the zone of interest of the door of the vehicle, generating a notification for a user of the vehicle, the notification warning the user that the door is not clear to open.

2. The method of claim 1, wherein the operations further include receiving vehicle data of the vehicle, the vehicle data comprising one or more of:
vehicle position;
vehicle steering; or
vehicle speed.

3. The method of claim 2, wherein mapping the sensor data to generate the depth map of the proximity zone around the vehicle comprises reconciling the vehicle data of the vehicle with the sensor data captured by the sensor system of the vehicle.

4. The method of claim 1, wherein the operations further comprise receiving seat data indicating that a seat associated with door of the vehicle is occupied.

5. The method of claim 4, wherein generating the notification warning the user that the door is not clear to open comprises identifying the zone of interest that corresponds to the occupied seat.

6. The method of claim 1, wherein generating the notification to the user of the vehicle comprises displaying, on a display in communication with the data processing hardware, the notification.

7. The method of claim 6, wherein generating the notification to the user of the vehicle further comprises one or more of:
locking the door that is not clear to open;
generating a visual alert; or
generating an audio alert.

8. The method of claim 1, wherein the zone of interest is configured during a configuration process.

9. The method of claim 1, wherein a dimension of the zone of interest is adjustable.

10. The method of claim 1, wherein the operations further comprise detecting a vehicle gear of the vehicle and generating the notification for the user of the vehicle when the vehicle gear indicates that the vehicle is parked.

11. A computer-implemented method when executed on data processing hardware causes the data processing hardware to perform operations comprising:
while a vehicle is executing a parking procedure:
receiving sensor data captured by a sensor system of the vehicle;
mapping the sensor data to generate a depth map of a proximity zone around the vehicle, the depth map including an object in the proximity zone around the vehicle;
determining whether the object in the proximity zone is within a zone of interest corresponding to a door of the vehicle; and
when the object is within the zone of interest of the door of the vehicle, displaying, on a display in communication with the data processing hardware, an indication highlighting the zone of interest.

12. The method of claim 11, wherein the operations further include receiving vehicle data of the vehicle, the vehicle data comprising one or more of vehicle steering or vehicle speed.

13. The method of claim 12, wherein mapping the sensor data to generate the depth map of the proximity zone around the vehicle comprises reconciling the vehicle data of the vehicle with the sensor data captured by the sensor system of the vehicle.

14. A system comprising:
data processing hardware; and
memory hardware in communication with the data processing hardware, the memory hardware storing instructions that when executed on the data processing hardware cause the data processing hardware to perform operations comprising:
receiving sensor data captured by a sensor system of a vehicle;
mapping the sensor data to generate a depth map of a proximity zone around the vehicle, the depth map including an object in the proximity zone around the vehicle;
determining whether the object in the proximity zone is within a zone of interest corresponding to a door of the vehicle; and
when the object is within the zone of interest of the door of the vehicle, generating a notification for a user of the vehicle, the notification warning the user that the door is not clear to open.

15. The system of claim 14, wherein the operations further include receiving vehicle data of the vehicle, the vehicle data comprising one or more of:
vehicle position;
vehicle steering; or
vehicle speed.

16. The system of claim 15, wherein mapping the sensor data to generate the depth map of the proximity zone around the vehicle comprises reconciling the vehicle data of the vehicle with the sensor data captured by the sensor system of the vehicle.

17. The system of claim 14, wherein the operations further comprise receiving seat data indicating that a seat associated with door of the vehicle is occupied.

18. The system of claim 17, wherein generating the notification warning the user that the door is not clear to open comprises:
identifying the zone of interest that corresponds to the occupied seat; and
displaying, on a display in communication with the data processing hardware, the notification.

19. The system of claim 14, wherein generating the notification to the user of the vehicle comprises one or more of:
locking the door that is not clear to open;
generating a visual alert; or
generating an audio alert.

20. The system of claim 14, wherein the zone of interest is configured during a configuration process.
